(19) United States
(12) Patent Application Publication
(10) Pub. No.: US 2011/0130480 A1
(43) Pub. Date: Jun. 2, 2011

(54) COPOLYESTER FOR SHRINK FILM APPLICATIONS

(75) Inventor: Uwe Bayer, Gesserthausen (DE)

(73) Assignee: INVISTA North America S.a.r.I.

(21) Appl. No.: 12/993,034

(22) PCT Filed: Jul. 2, 2009
(86) PCT No.: PCT/IB09/06358

§ 371 Date: Feb. 11, 2011

Related U.S. Application Data
(60) Provisional application No. 61/077,502, filed on Jul. 2, 2008.

(51) Int. Cl. C08L 67/02; C08G 63/183; B29C 47/14

(52) U.S. Cl. 521/182; 528/305; 523/122; 524/605; 264/177.1

(57) ABSTRACT

The present invention relates to a polyester composition comprising a diacid component and a diol component, wherein the diacid component comprises: i) isophthalic acid present at a concentration in the range of from about 23 mole % to about 30 mole % of the total diacid, and ii) terephthalic acid; and wherein the diol component comprises: i) diethylene glycol present at a concentration in the range of from about 1.1 mole % to about 3.5 mole % of the total diol, and ii) ethylene glycol. Other embodiments of the present invention include a film produced from the polyester composition and processes for producing the film.

### CROSS-REFERENCE TO RELATED APPLICATION

This application claims benefit of priority from U.S. Provisional Application No. 61/077,502 filed Jul. 2, 2008.

### FIELD OF INVENTION

This invention relates to heat-shrinkable films, more particularly to copolyester compositions comprising terephthalic acid, isophthalic acid, ethylene glycol and diethylene glycol that are useful to manufacture heat-shrinkable polyester films.

### BACKGROUND OF INVENTION

Heat-shrinkable plastic films are used to hold objects together and as an outer wrapping for bottles, cans and other kinds of containers. For example, such films are used for covering parts of or the entire container for the purpose of labeling and tamper protection of containers, and for wrapping groups of objects into a single package for handling and shipping.

Shrink films or heat-shrinkable films refer to uniaxially oriented films which are widely used as primary labels on soft drink bottles. The film primarily shrinks in the stretched direction and has a little shrinkage in the unstretched direction. The films are manufactured on conventional film lines in which the molten polymer is extruded onto a chilled roll, heated to a temperature above the polymer glass transition temperature and drawn in the transverse direction about 4 to 5 times. The film is annealed at a temperature about the polymer glass transition temperature, cooled, slit and wound up on rolls. The film roll is unwound printed, folded, and an adhesive solvent applied to one edge. A seal is formed by overlapping the edges and applying pressure to obtain a firm seal, and rewound. The film is then cut to the desired length, opened into a tube and after being wrapped around an article, for example a bottle, the film is shrunk by the application of heat, either by hot air, infra red energy or steam, in an oven. Typically, the adhesive solvent is tetrahydrofuran or a mixture of tetrahydrofuran with up to 33 vol. % of 1,3-dioxolane.

The materials conventionally used for the heat-shrinkable films mentioned above include polyvinylchloride (PVC), polystyrene (OPS), oriented polyethylene, oriented polypropylene, and certain copolyesters. PVC is the most widely used material due to its excellent shrink properties and clarity. However, environmental concerns exist with PVC. Substitute materials, which are more environmentally friendly and recyclable, should have comparable heat-shrink properties.

Polymeric materials which are being used to substitute for PVC for shrink films are copolyesters based on 1,4-cyclohexanedimethanol copolyethylene terephthalate (known as PETG) and blends of PETG and other copolyesters. These copolyesters are disclosed in U.S. Pat. Nos. 5,859,116 and 6,362,306. These copolyesters have problems when used for heat-shrinkable films, such as low ductility or toughness, and a slight haze in the film. The cost of the 1,4-cyclohexanedimethanol (CHDM) monomer used to produce these copolyesters is also high.

Thus, there exists a need in the art to have a heat-shrinkable copolyester film with improved toughness, less haze and low cost.

### SUMMARY OF THE INVENTION

In accordance with the present invention, a polyester composition has been found that can be made into a heat-shrinkable film with improved toughness, less haze and low cost. The present invention can be characterized by a polyester composition comprising a diacid component and a diol component, wherein the diacid component comprises: i) isophthalic acid present at a concentration in the range of from about 23 mole % to about 30 mole % of the total diacid, and ii) terephthalic acid; and wherein the diol component comprises: i) diethylene glycol present at a concentration in the range of from about 1.1 mole % to about 3.5 mole % of the total diol, and ii) ethylene glycol. The present invention also relates to a film produced from the polyester composition and processes for producing the film.

### DETAILED DESCRIPTION OF THE INVENTION

The present invention can be characterized by a polyester composition comprising a diacid component and a diol component, wherein the diacid component comprises: i) isophthalic acid present at a concentration in the range of from about 23 mole % to about 30 mole % of the total diacid, and ii) terephthalic acid; and wherein the diol component comprises: i) diethylene glycol present at a concentration in the range of from about 1.1 mole % to about 3.5 mole % of the total diol, and ii) ethylene glycol. The isophthalic acid can be present at a concentration in the range of from about 23 mole % to about 30 mole % of the total diacid, for example from about 24 mole % to about 28 mole % of the total diacid. The diethylene glycol can be present at a concentration in the range of from about 1.1 mole % to about 3.5 mole % of the total diol, for example from about 1.5 mole % to about 3.2 mole % of the total diol or from about 2.7 mole % to about 3.2 mole % of the total diol. The terephthalic acid can be present at a concentration in the range of from about 70 mole % to about 77 mole % of the total diacid, for example from about 72 mole % to about 76 mole % of the total diacid. The ethylene glycol can be present at a concentration in the range of from about 96.5 mole % to about 98.9 mole % of the total diol, for example from about 96.8 mole % to about 98.5 mole % of the total diol or from about 96.8 mole % to about 97.3 mole % of the total diol. The isophthalic acid and diethylene glycol can be present at a sum concentration of from about 24 mole % to about 33 mole % of the total composition, for example from about 27 mole % to about 31 mole % of the total composition. Suitably the molecular weight of the copolyester (Inherent Viscosity, IhV) can be about 0.65 dl/g or more, for example about 0.70 dl/g or more, to have sufficient melt viscosity for casting a film. The IhV can be chosen knowing that there is a high (about 0.05 to 0.1 dl/g) loss in IhV in melt extrusion, due to the level of moisture after drying at the low temperatures required for these copolyesters containing a high amount of comonomers. Suitably, the glass transition temperature (Tg) of the composition can be about 70° C. or more. Generally, the relationship of glass transition temperature (Tg) with isophthalic acid (IPA) and diethylene glycol (DEG) can be represented by the following equation:

Tg(° C.)=80.95−0.18 IPA[mole %]−1.74 DEG [mole %]

This relationship is accurate in an IPA concentration range of from about 6 mole % to about 33 mole % and in a DEG concentration range of from about 1.1 mole % to about 3.5 mole %. Generally, an isophthalic acid concentration of about 20 mole % or more results in an amorphous stretched film. Therefore, a DEG concentration of about 3.5 mole % or less can produce a Tg of about 70° C. or more.

The above embodiment of the present can further comprise an additive. The additive can be at least one member selected from the group consisting of dye, pigment, filler, branching agent, anti-blocking agent, antioxidant, anti-static agent, biocide, blowing agent, coupling agent, flame retardant, heat stabilizer, impact modifier, ultraviolet light stabilizer, visible light stabilizer, lubricant, plasticizer, processing aid, acetaldehyde, oxygen scavenger, barrier polymer, slip agent, and mixtures thereof. The additive can be added during polymerization or as a master batch at the melt extrusion of the film.

Another embodiment of the present invention is a film comprising a polyester composition comprising a diacid component and a diol component, wherein the diacid component comprises: i) isophthalic acid present at a concentration in the range of from about 23 mole % to about 30 mole % of the total diacid, and ii) terephthalic acid; and wherein the diol component comprises: i) diethylene glycol present at a concentration in the range of from about 1.1 mole % to about 3.5 mole % of the total diol, and ii) ethylene glycol. The film can be a shrinkable film, for example a heat-shrinkable film. The film can have a toughness of about 200 MPa or more when processed at a stretch ratio of 5:1 at a temperature of about 80° C. The shrinkage of the film in the stretched direction can be about 50% or more at 80° C. The shrinkage of the film in the stretched direction can be about 55% or more at 90° C. The shrinkage of the film in the non-stretched direction can be about 10% or less at 80° C. The density of the film can be about 1.350 g/cm³ or less, for example about 1.340 g/cm³ or less. The film can have a haze of about 1% or less through a thickness of 0.05 mm. Suitably, the inherent viscosity (IhV) of the film can be about 0.60 dl/g or more, for example about 0.65 dl/g or more. Suitably, the glass transition temperature (Tg) of the polyester composition can be about 70° C. or more.

In the above embodiment of the present invention the isophthalic acid can be present at a concentration in the range of from about 23 mole % to about 30 mole % of the total diacid, for example from about 24 mole % to about 28 mole % of the total diacid. The diethylene glycol can be present at a concentration in the range of from about 1.1 mole % to about 3.5 mole % of the total diol, for example from about 1.5 mole % to about 3.2 mole % of the total diol or from about 2.7 mole % to about 3.2 mole % of the total diol. The terephthalic acid can be present at a concentration in the range of from about 70 mole % to about 77 mole % of the total diacid, for example from about 72 mole % to about 76 mole % of the total diacid. The ethylene glycol can be present at a concentration in the range of from about 96.5 mole % to about 98.9 mole % of the total diol, for example from about 96.8 mole % to about 98.5 mole % of the total diol or from about 96.8 mole % to about 97.3 mole % of the total diol. The isophthalic acid and diethylene glycol can be present at a sum concentration of from about 24 mole % to about 33 mole % of the total composition, for example from about 27 mole % to about 31 mole % of the total composition.

Another embodiment of the present invention is a film comprising a polyester composition, wherein the film has i) a shrinkage in the stretched direction of about 50% or more at 80° C., and ii) a toughness of about 200 MPa or more. The shrinkage of the film in the stretched direction can be about 55% or more at 90° C. The film can further have a shrinkage in the non-stretched direction of about 10% or less at 80° C. The film can be a heat-shrinkable film. The density can be about 1.350 g/cm³ or less, for example about 1.340 g/cm³ or less. The film can have a haze of less than about 1% through a thickness of 0.05 mm. Suitably, the inherent viscosity (IhV) of the film can be about 0.60 dl/g or more, for example about 0.65 dl/g or more. Suitably, the glass transition temperature (Tg) of the polyester composition can be about 70° C. or more.

Another embodiment of the present invention is a process for making the film comprising: i) extruding the polyester composition at a temperature in the range of from about 245° C. to 260° C., and ii) stretching the cast film in one direction at from about 20% per second to about 30% per second with a constant draw ratio of from about 4.0 to about 5.5.

Polyester compositions useful in uniaxially oriented films for use in heat-shrinkable applications, such as labels, can have a glass transition temperature of the polyester composition of about 70° C. or more; a lower Tg causes tackiness and uneven drawing in the film process and will increase the time to dry the copolyester. Typically, for good solvent seaming performance the film needs to be amorphous, a slight degree of crystallization, generally formed during the film stretching process, reduces the rate and uniformity of penetration of the solvent. An amorphous uniaxially drawn film will not show a crystallization exotherm or an endotherm melting peak during the second heating cycle of a DSC analysis. Alternatively, for an amorphous drawn film, the density can be about 1.350 g/cm³ or less, for example about 1.340 g/cm³ or less.

The copolyester compositions can be prepared by conventional polymerization methods using a trans-esterification of the ester of the diacids or the direct esterification of the diacids. For transesterification conventional catalyst compounds based on manganese, zinc, etc. can be used, or combinations of these, sequestered with a phosphorus compound prior to polycondensation. Typical polycondensation catalyst compounds based on antimony, germanium, titanium, aluminum, tin, etc are used, or combinations of these. Titanium compounds can also be used to catalyze the trans-esterification reaction. The color tone of the copolyester can be adjusted by additives such as cobalt salts, inorganic or organic dyes and pigments.

The copolyester compositions are formed into films by melt extrusion of the dried copolyester onto a chilled set of casting rolls. The stretching of the films can be by any usual method such the tenter stretching method. The stretching in the transverse direction can be done by heating the film to a temperature in the range of about Tg to Tg+20° C., for example in the range of about Tg+10° C. to Tg+20° C. The stretch ratio can be in the range of about 4 to about 5.5×, for example about 4.5 to 5.5×. The stretch rate can be in the range of from about 10 to 50 cm·sec⁻¹. A slight stretch in the machine direction can be used to provide a film that shrinks uniformly on heating. The final thickness of the uniaxially drawn film can be in the range of about 0.05 to 0.5 mm, for example in the range of 0.2 to 0.4 mm.

The shrinkage characteristics of the film can be optimized by the stretch ratio and temperature of drawing. It is important it obtain a film that shrinks at a uniform rate as it is heated in the shrink tunnel to minimize wrinkles, and be able to shrink at high temperatures (95° C.) more than about 60% for labeling contoured bottles.

Test Methods

Inherent Viscosity is measured according the method of ASTM D 4603-96, using dichloroacetic acid as the solvent.

Glass transition temperature (Tg) is measured according to ASTM D 3418-97. A sample of about 10 mg is cut from various sections of the polymer chip and sealed in an aluminum pan. A scan rate of 10° C./min. is used in a TA Instruments DSC Q-100 DSC unit under a nitrogen atmosphere. The sample is heated to 300° C., held for 5 minutes and cooled to 0° C. at a scan rate of 10° C./min prior to the second heating cycle. The Tg is measured on the 2^{nd} heating cycle. The DSC heating scans (1^{st} and 2^{nd} heating cycles) are used to determine whether the copolyester composition exhibited any crystallinity.

The density of the stretched film equals the total density (measured using a density column) minus the density of any additives; such that the final reported density of the stretched film only represents that of the copolyester stretched film and not that of the additives plus the copolyester stretched film.

Thermal shrinkage of the stretched films is determined from a sample cut from the center of the stretched film. The sample, length L₀, is placed in a holder, free from contact with the edges of the holder, and immersed in a constant temperature bath for 30 seconds. The water bath temperature is controlled at various temperatures. The sample is removed from the bath and quickly dried at room temperature. The thermal shrinkage is calculated by measuring the linear dimensions, L₁, of the shrunk sample. The percent shrinkage is calculated as follows:

S,%=(L₀−L₁)/L₀×100%

The seam strength is measured subjectively by assessing the manual force required to open the seam.

The film physical properties are measured according to ASTM D 882-02. Toughness is defined as the product of tensile strength (MPa) and elongation at break (%/100).

The optical properties, haze, transmittance and clarity are measured with a BYK-Gardner Haze-guard spectrophotometer according to ASTM D 1003-00. Gloss is measured at a 45° angle according to ASTM D 2457-03.

The diethylene glycol (DEG) content of the polymer is determined by hydrolyzing the polymer with a solution of KOH in methanol in a reaction vessel with air cooler refluxing at 135±5° C. for approximately 2.5 hours. The KOH in methanol is at concentration of 1.5 moles/L. The KOH is available from Merck and is analytical purity. As internal standard tetraethyleneglycol dimethyl ether is used. After cooling to room temperature, the solution is neutralized with aqueous. HCl. The aqueous HCl is at a concentration of about 27%. The suspension is then filtrated and the filtrate is then analyzed by gas chromatography. The gas chromatography apparatus is a FID Detector (Focus GC) from Thermo Electron.

The isophthalic acid (IPA) content of the polymer is determined using a Surveyor LS from ThermoFisher (HPLC) with an UV Detector. The analysis is done via saponification of the polymer sample with KOH in methanol at 120° C. for 1 hour under reflux. After cooling, the contents were neutralized with HCl, filtered over a folded filter. About 100 μl of the filtrate is added into an autosampler vial and diluted with 900 μl methanol. 5-Hydroxy-isophthalte is used as internal standard; the standard is added before saponification of the polymer. The solution is analyzed by HPLC at 240 nm using an isocratic eluent (85% [water with 1.0 volume % acetic acid] and 15% acetonitrile).

### EXAMPLES

The copolyesters are prepared by mixing a given amount of IPA in a paste tank of terephthalic acid and ethylene glycol. DEG is formed naturally during the esterification reaction, and additional DEG is added to the paste as necessary.

### Example 1

Copolyesters containing a range of IPA and DEG comonomer amounts were prepared and converted into a stretched film. Samples 1 and 2 represent the present invention. Samples 3 and 4 represent comparative compositions. Additionally, a sample of PETG (Embrace Copolyester available from Eastman) was used as a control. Analysis of this PETG resin indicated a composition containing 19.8 mole % CHDM and 9.5 mole % DEG, having an IhV of 0.80 and a Tg of 71.1° C. The comonomer concentrations for Samples 1-4 are set forth in Table 1.

TABLE 1

| | IPA, | DEG, | Total | Inherent | |
|---|---|---|---|---|---|
| | mole % | mole % | Comonomer, | Viscosity, | |
| Sample | of diacids | of diols | Mole % | dl/g | Tg. ° C. |
| 1 (Inventive) | 24.3 | 2.99 | 27.3 | 0.68 | 72.8 |
| 2 (Inventive) | 27.8 | 3.12 | 30.9 | 0.70 | 72.2 |
| 3 (Comparative) | 19.8 | 2.95 | 22.7 | 0.66 | 74.0 |
| 4 (Comparative) | 17.6 | 1.2 | 18.8 | 0.71 | 75.5 |

The cast film was prepared on a pilot plant machine, extruding the melt at 253° C. through a die of width 200 cm onto a chilled roll (70° C.) operating at 2.3 to 2.6 m/min. to give an unoriented film thickness of 250 micron. The cast film was stretched in one direction (TD) at 25%/sec on a laboratory film stretcher at different drawing temperatures (75, 80 and 90° C.) using a constant draw ratio of 5.0 for each run. A 12×12 cm sample was cut from the film for testing.

The seam strength of films stretched at 80° C. using different solvents (tetrahydrofuran (THF), 1,3-dioxolane (1,3-D) and vol. % mixtures), the IhV and the density, for the films stretched at 80° C. was measured and the results set forth in Table 2.

TABLE 2

| | | Seam Strength (visual rating) | | | | |
|---|---|---|---|---|---|---|
| | | Solvent | | | | |
| | Inherent | | | 70% | 80% | |
| | Viscosity, | 100% | 100% | THF/30% | THF/20% | Density, |
| Sample | dl/g | THF | 1,3-D | 1,3-D | 1,3-D | g/cm³ |
| 1 | 0.63 | weak | satis- | weak | weak | 1.345 |
| | | | factory | | | |
| 2 | 0.65 | weak | good | satisfactory | satisfactory | 1.339 |
| 3 | 0.58 | none | weak | none | weak | 1.352 |
| 4 | 0.66 | none | none | none | none | 1.355 |
| PETG | 0.66 | good | good | good | good | 1.319 |

Sample 4 had such poor seam strength that the sample was not further tested for shrinkage, physical properties or optical properties.

The shrinkage of the films in the stretched direction (TD), stretched at the different temperatures, were measured at 70, 80, 90 and 95° C., and the results set forth in Table 3.

TABLE 3

| | Process Stretch | Shrinkage TD, % at different temperatures | | | |
|---|---|---|---|---|---|
| Sample | Temp., ° C. | 70° C. | 80° C. | 90° C. | 95° C. |
| 1 | 75 | 30 | 61 | 72 | 74 |
| | 80 | 18 | 46 | 53 | 58 |
| | 90 | 37 | 56 | 59 | 66 |
| 2 | 75 | 41 | 71 | 77 | 79 |
| | 80 | 28 | 56 | 67 | 73 |
| | 90 | 39 | 54 | 66 | 69 |
| 3 | 75 | 20 | 51 | 57 | 62 |
| | 80 | 12 | 37 | 42 | 44 |
| | 90 | 34 | 52 | 57 | 60 |
| PETG | 75 | 43 | 66 | 75 | 76 |
| | 80 | 34 | 52 | 61 | 66 |
| | 90 | 36 | 54 | 64 | 66 |

The shrinkage of these films was measured in the non-stretched direction (MD) and the results set forth in Table 4.

TABLE 4

| | Process Stretch | MD Shrinkage, % at different temperatures | | | |
|---|---|---|---|---|---|
| Sample | Temp., ° C. | 70° C. | 80° C. | 90° C. | 95° C. |
| 1 | 75 | 2.5 | 8.8 | 10 | 5.1 |
| | 80 | 0 | 4.4 | 3.2 | 1.9 |
| | 90 | 12.5 | 16.3 | 11.9 | 10 |
| 2 | 75 | 7.5 | 12.5 | 10 | 6.9 |
| | 80 | 2.5 | 8.8 | 7.5 | 6.3 |
| | 90 | 13.8 | 18.2 | 16.3 | 12.5 |
| 3 | 75 | −2.5 | 5.7 | 2.5 | 2.5 |
| | 80 | −1.9 | 0 | 0 | −0.7 |
| | 90 | 9.4 | 16.9 | 12.5 | 12.5 |
| PETG | 75 | 6.3 | 10.1 | 12.5 | 12.5 |
| | 80 | 8.2 | 8.8 | 5 | 6.3 |
| | 90 | 13.2 | 18.8 | 16.3 | 13.8 |

### Example 2

The physical properties of the films prepared in Example 1 were measured in the TD and the results set forth in Table 5.

TABLE 5

| | Stretch | Tensile | Elongation | | Young's |
|---|---|---|---|---|---|
| | Temp., | Strength, | at Break, | Toughness, | Modulus. |
| Sample | ° C. | MPa | % | MPa | MPa |
| 1 | 75 | 384 | 53 | 204 | 7,777 |
| | 80 | 359 | 71 | 255 | 6,295 |
| | 90 | 142 | 181 | 257 | 3,192 |
| 2 | 75 | 408 | 59 | 241 | 7,050 |
| | 80 | 339 | 76 | 258 | 5,585 |
| | 90 | 143 | 153 | 219 | 3,370 |
| 3 | 75 | 366 | 49 | 179 | 8,257 |
| | 80 | 370 | 66 | 244 | 7,137 |
| | 90 | 147 | 189 | 278 | 3,153 |
| PETG | 75 | 301 | 39 | 117 | 6,156 |
| | 80 | 247 | 63 | 156 | 4,528 |
| | 90 | 151 | 209 | 316 | 2,312 |

### Example 3

The optical properties of the films produced in Example 1 were measured and the results set forth in Table 6.

TABLE 6

| | Stretch | Transmittance, | Haze, | Clarity, | Gloss, |
|---|---|---|---|---|---|
| Sample | Temp., ° C. | % | % | % | at 45° |
| | 75 | 92.4 | 0.43 | 99.9 | 115 |
| 1 | 80 | 92.4 | 0.42 | 100 | 115 |
| | 90 | 93.2 | 0.36 | 99.7 | 113 |
| | 75 | 92.3 | 0.64 | 99.8 | 115 |
| 2 | 80 | 92.7 | 0.55 | 99.9 | 115 |
| | 90 | 93.3 | 0.54 | 99.6 | 112 |
| | 75 | 91.8 | 0.54 | 99.9 | 116 |
| 3 | 80 | 92.5 | 0.44 | 99.8 | 116 |
| | 90 | 93.1 | 0.55 | 99.4 | 112 |
| | 75 | 92.2 | 1.85 | 99.1 | 111 |
| PETG | 80 | 92.8 | 2.07 | 98.7 | 109 |
| | 90 | 93.4 | 4.05 | 91.4 | 99 |

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A polyester composition comprising a diacid component and a diol component,
wherein the diacid component comprises: i) isophthalic acid present at a concentration in the range of from about 23 mole % to about 30 mole % of the total diacid, and ii) terephthalic acid; and
wherein the diol component comprises: i) diethylene glycol present at a concentration in the range of from about 1.1 mole % to about 3.5 mole % of the total diol, and ii) ethylene glycol.

2. The polyester composition of claim 1 wherein the isophthalic acid is present at a concentration in the range of from about 24 mole % to about 28 mole % of the total diacid.

3. The polyester composition of claim 1 wherein the diethylene glycol is present at a concentration in the range of from about 1.5 mole % to about 3.2 mole % of the total diol.

4. The polyester composition of claim 1 wherein the diethylene glycol is present at a concentration in the range of from about 2.7 mole % to about 3.2 mole % of the total diol.

5. The polyester composition of claim 1 wherein the isophthalic acid and diethylene glycol are present at a sum concentration of from about 24 mole % to about 33 mole % of the total composition.

6. The polyester composition of claim 1 wherein the isophthalic acid and diethylene glycol are present at a sum concentration of from about 27 mole % to about 31 mole % of the total composition.

7. The polyester composition of claim 1 wherein the composition has a glass transition temperature of about 70° C. or more.

8. The polyester composition of claim 1 wherein the composition has an inherent viscosity of about 0.65 dl/g or more.

9. The polyester composition of claim 1, 7 or 8 further comprising an additive.

10. The polyester composition of claim 9 wherein the additive comprises at least one member selected from the group consisting of dye, pigment, filler, branching agent, anti-blocking agent, antioxidant, anti-static agent, biocide, blowing agent, coupling agent, flame retardant, heat stabilizer, impact modifier, ultraviolet light stabilizer, visible light stabilizer, lubricant, plasticizer, processing aid, acetaldehyde, oxygen scavenger, barrier polymer, slip agent, and mixtures thereof.

11. A film comprising the polyester composition of claim 1.

12. The film of claim 11 wherein the film is a heat-shrinkable film.

13. The film of claim 11 wherein the film has a toughness of about 200 MPa or more.

14. The film of claim 11 wherein the film has a haze of about 1% or less measured through a film thickness of 0.05 mm.

15. The film of claim 11 wherein the film has a shrinkage in the stretched direction of about 50% or more at 80° C.

16. The film of claim 11 wherein the film has a shrinkage in the stretched direction of about 55% or more at 90° C.

17. The film of claim 15 or 16 wherein the film further has a shrinkage in the non-stretched direction of about 10% or less at 80° C.

18. The film of claim 11 wherein the film has a density of about 1.350 g/cm³ or less.

19. The film of claim 18 wherein the film has a density of about 1.340 g/cm³ or less.

20. The film of claim 11 wherein the film has an inherent viscosity of about 0.60 dl/g or more.

21. A film comprising a polyester composition, wherein the film has i) a shrinkage in the stretched direction of about 50% or more at 80° C., and ii) a toughness of about 200 MPa or more.

22. The film of claim 21 wherein the film is a heat-shrinkable film.

23. The film of claim 21 wherein the film has a haze of about 1% or less measured through a film thickness of 0.05 mm.

24. The film of claim 21 wherein the film has a shrinkage in the stretched direction of about 55% or more at 90° C.

25. The film of claim 24 or 24 wherein the film further has a shrinkage in the non-stretched direction of about 10% or less at 80° C.

26. The film of claim 21 wherein the film has a density of about 1.350 g/cm³ or less.

27. The film of claim 21 wherein the film has a density of about 1.340 g/cm³ or less.

28. The film of claim 21 wherein the film has an inherent viscosity of about 0.60 dl/g or more.

29. A process for making the film of claim 11 or 21 comprising:
i) extruding the polyester composition at a temperature in the range of from about 245° C. to 260° C., and
ii) stretching the cast film in one direction at from about 20% per second to about 30% per second with a constant draw ratio of from about 4.0 to about 5.5.
